(19) United States
(12) Patent Application Publication
(10) Pub. No.: US 2003/0233507 A1
(43) Pub. Date: Dec. 18, 2003

(54) Electronic card with multiple interfaces

(75) Inventors: John Yu, Keelung City (TW); Caph Chen, Kaohsiung City (TW)

Correspondence Address: BACON & THOMAS, PLLC, 625 SLATERS LANE, FOURTH FLOOR, ALEXANDRIA, VA, 22314

(73) Assignees: C-One Technology Corporation; Pretec Electronics Corporation

(21) Appl. No.: 10/167,480

(22) Filed: Jun. 13, 2002

(51) Int. Cl. G06F 13/36

(52) U.S. Cl. 710/310

(57) ABSTRACT

The present invention discloses an electronic card with multiple interfaces, which includes a first and a second interface connection port, an interface signal converter, a first and a second switch device and a card loading detection device. The interface signal converter converts second interface connection port signals to predetermined interface signals. The first switch device is arranged between the second interface connection port and the interface signal converter. The second switch device is arranged between the interface signal converter and the predetermined interface. The card loading detection device detects whether the first interface connection port is connected to an electronic device. If the first interface connection port is connected to an electronic device, the card loading detection device turns off the first and second switch devices.

### BACKGROUND OF THE INVENTION

1. Field of the Invention

The present invention relates to an electronic card and, more particularly, to an electronic card with multiple interfaces.

2. Description of Related Art

With advances in electronic technology, various electronic devices, such as notebook computers, palm computers, PDAs (personal digital assistants), are getting smaller in size. These diminutive electronic devices provide convenience to the user due to their portability and data processing capability. However, because of their small size, such an electronic device generally has only basic processing circuitry. For other circuit modules, such as add-on memory, modem, network card, etc., have to be provided to the electronic device by inserting a corresponding electronic card therein. This electronic card can also be inserted into a personal computer for enabling data communications or increasing storage space.

Conventionally, such an electronic card has one interface only, for example, an USB or Compact Flash (CF) interface. Therefore, this electronic card can only be plugged into a corresponding slot. If the electronic device does not provide the corresponding slot or the corresponding slot has been occupied by another electronic card, this electronic card cannot be plugged into the electronic device and cannot be used.

Therefore, it is desirable for the above conventional electronic card to be improved so as to mitigate and/or obviate the aforementioned problems.

### SUMMARY OF THE INVENTION

The objective of the present invention is to provide an electronic card with multiple interfaces that dramatically increases electronic card applications.

To achieve the objective, the electronic card with multiple interfaces of the present invention includes: at least two interface connection ports, which includes a first interface connection port and a second interface connection port; an interface signal converter for converting second interface port connection signals to predetermined interface signals, the predetermined interface corresponding and connecting to the first interface connection port; a first switch device arranged between the second interface connection port and the interface signal converter; a second switch device arranged between the interface signal converter and the predetermined interface; and at least one card loading detection device for detecting whether the first interface connection port is connected to an electronic device, wherein, if the first interface connection port is connected to an electronic device, the card loading detection device turns off the first and second switch devices, if the first interface connection port is not connected to an electronic device the card loading detection device turns on the first and second switches.

Other objectives, advantages, and novel features of the invention will become more apparent from the following detailed description when taken in conjunction with the accompanying drawings.

### BRIEF DESCRIPTION OF THE DRAWINGS

FIG. 1 is a block diagram of the electronic card with multiple interfaces in accordance with a first embodiment of the present invention;

FIG. 2 is a circuit diagram of the card loading detection device shown in FIG. 1;

FIG. 3 is a circuit diagram of the first switch device shown in FIG. 1;

FIG. 4 is a circuit diagram of the second switch device shown in FIG. 1;

FIG. 5 is a block diagram of the electronic card with multiple interfaces in accordance with a second embodiment of the present invention; and

FIG. 6 is a block diagram of the electronic card with multiple interfaces in accordance with a third embodiment of the present invention.

### DETAILED DESCRIPTION OF THE PREFERRED EMBODIMENT

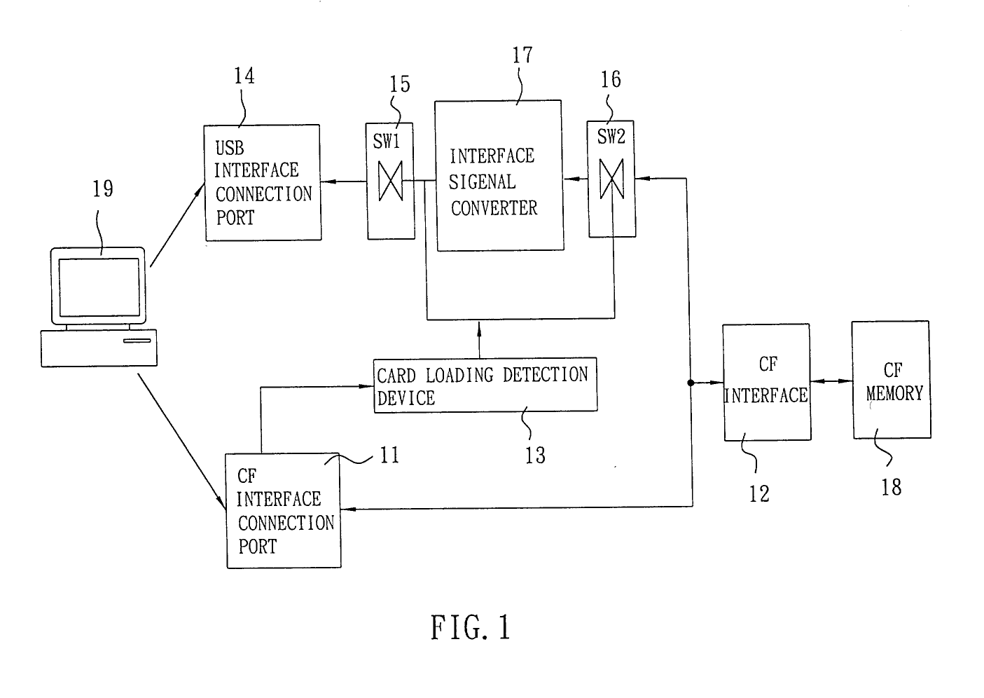

With reference to FIG. 1, there is shown a preferred embodiment of an electronic card with multiple interfaces in accordance with the present invention, wherein the electronic card in this embodiment is a memory card with a CF interface and an USB interface. When the CF interface is active, the USB interface is automatically off-line such that both interface signals will not interfere with each other.

As shown in FIG. 1, the memory card with multiple interfaces includes a CF interface connection port 11, a CF interface 12, a card loading detection device 13, an USB interface connection port 14, a first switch device 15, a second switch device 16, an interface signal converter 17 and a CF memory 18. The CF interface connection port 11 and the USB interface connection port 14 are provided to plug the memory card into the CF or USB interface slot of an electronic device, such as a PC 19 (Personal Computer). When the CF interface connection port 11 is connected to the PC 19, the card loading detection device 13 detects the connection status and outputs a control signal to turn off the first and second switch devices 15 and 16, so as to isolate the USB interface connection port 14 from the interface signal converter 17 and the CF interface connection ports 11, thereby preventing the USB signals from interfering with the CF interface 12, allowing accurate data transfer to/from the CF memory 18.

When the CF interface connection port 11 is disconnected from the PC 19, the card loading detection device 13 detects the connectionless status and outputs a control signal to turn on the first and second switches 15 and 16, such that the USB interface connection port 14 can be connected to the PC 19. With the interface signal converter 17 conversion, the USB interface signals can be converted into CF interface signals, so as to transfer data to/from the CF memory 18.

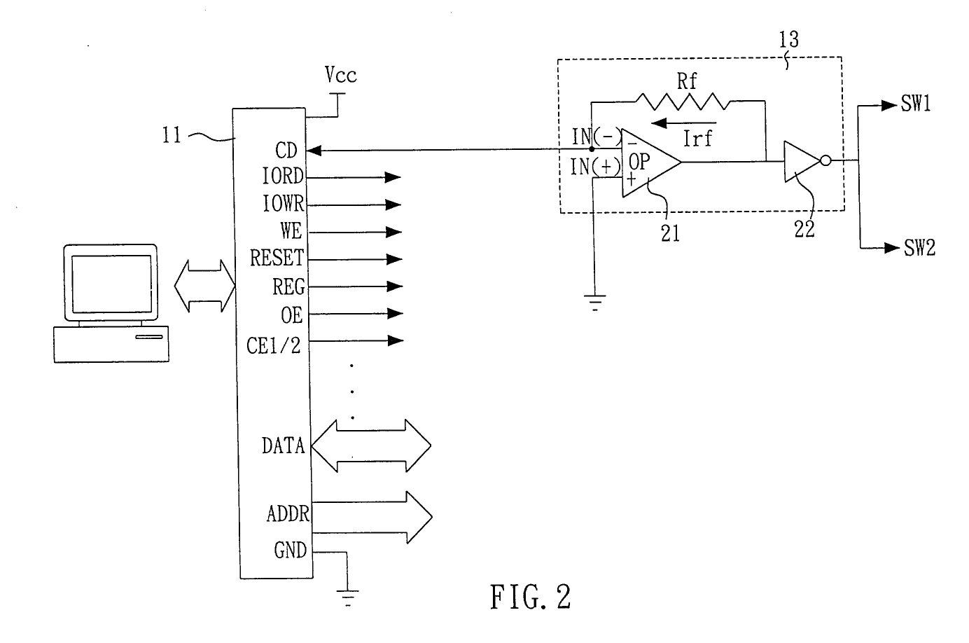

FIG. 2 is a circuit of the card loading detection device 13 shown in FIG. 1. As known to those skilled in the art, there is a card detection (CD) pin specified in the CF interface specification, this pin is in a “low” state when an electronic card is plugged in the CF interface. Thus, when the CF interface connection port 11 connects with the PC 19, the CF interface connection port 11 CD pin is grounded and induces a short-circuit current. The card loading detection device 13 has an OP amplifier 21 to detect the short-circuit current, wherein the OP amplifier 21 positive input IN (+) connects to ground, and the negative input IN (−) is connected to the CD pin and the OP amplifier 21 output via a feedback resistor Rf. With this negative feedback, the differential voltage between the positive input IN (+) and the negative input IN (−) is close to zero; that is, the positive input IN (+) and the negative input IN (−) are virtually grounded. Thus, there is a feedback current Irf flowing into the negative input IN (−) and a voltage is induced onto the feedback resistor Rf. The inverter 22, uses the inverted voltage to control the first and second switches 15 and 16.

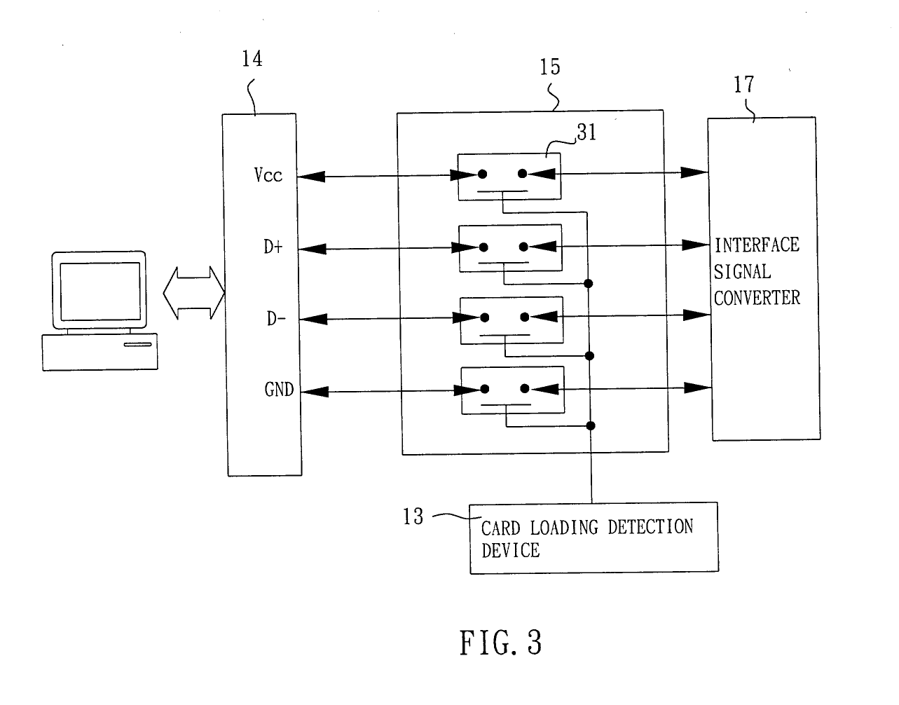

FIG. 3 is a circuit of the first switch 15 shown in FIG. 1, which includes a plurality of analog switches 31, each connecting one USB interface connection port 14 pin to the interface signal converter 17. The analog switches 31 on or off positions are controlled by the card loading detection device 13.

The aforementioned interface signal converter 17 is a serial to parallel signal converter. It can convert the USB interface serial signals (VCC, D+, D−, GND) to CF interface parallel signals (Control, Address, Data).

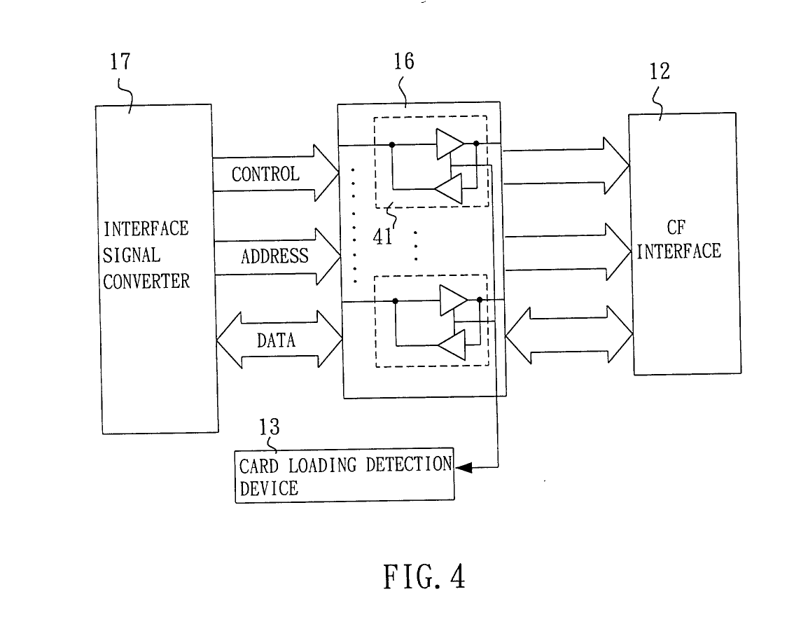

FIG. 4 is a circuit of the second switch device 16 shown in FIG. 1, which includes a plurality of bi-directional tri-state buffers 41, each connecting one interface signal converter 17 pin to the CF interface 12. The bi-directional tri-state buffers 41 on or off positions are controlled by the card loading detection device 13.

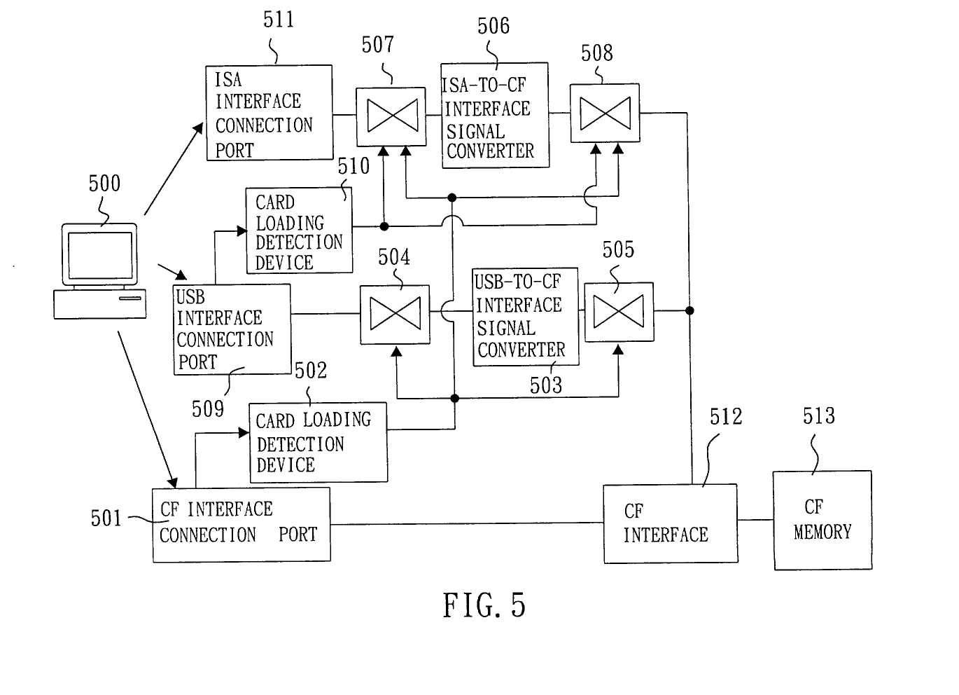

The aforementioned electronic card with CF and USB interfaces can be expanded to have three or more interfaces. As shown in FIG. 5, the second preferred embodiment of the present invention is a memory card with CF, USB and ISA interfaces, wherein the card loading detection device 502 for detecting the CF interface connection port 501 simultaneously controls the switch devices 504 and 505 at two ends of an USB-to-CF interface signal converter 503 and the switch devices 507 and 508 at two ends of an ISA-to-CF interface signal converter 506. The card loading detection device 510 for detecting the USB interface connection port 509 controls the switch devices 507 and 508 at two ends of the ISA-to-CF interface signal converter 506. Accordingly, when the CF interface connection port 501 connects to the PC 500, the card loading detection device 502 simultaneously turns off the switch devices 504, 505, 507 and 508 to isolate the USB and ISA signals from the CF interface 512, thereby ensuring correct CF memory 513 operation.

When the CF interface connection port 501 is not connected to the PC 500 and the USB interface connection port 509 is connected to the PC 500, the card loading detection device 510 turns off the switch devices 507 and 508 to isolate the ISA interface signals from the CF interface 512, so as to prevent the CF interface 512 from being interfered with. The switch devices 504 and 505 are turned on, such that USB interface connection port 509 signals can be converted to CF interface 512 signals by the USB-to-CF interface signal converter 503, whereby the host can access the CF memory 513 through the USB interface. When the CF interface connection port 501 and the USB interface connection port 509 are not connected and the ISA interface connection port 511 is connected to the PC 500, the switch devices 507 and 508 are on, such that the ISA interface connection port 511 signals can be converted into CF interface 512 signals by the ISA-to-CF interface signal converter 506, whereby the host can access the CF memory 513 through the ISA interface.

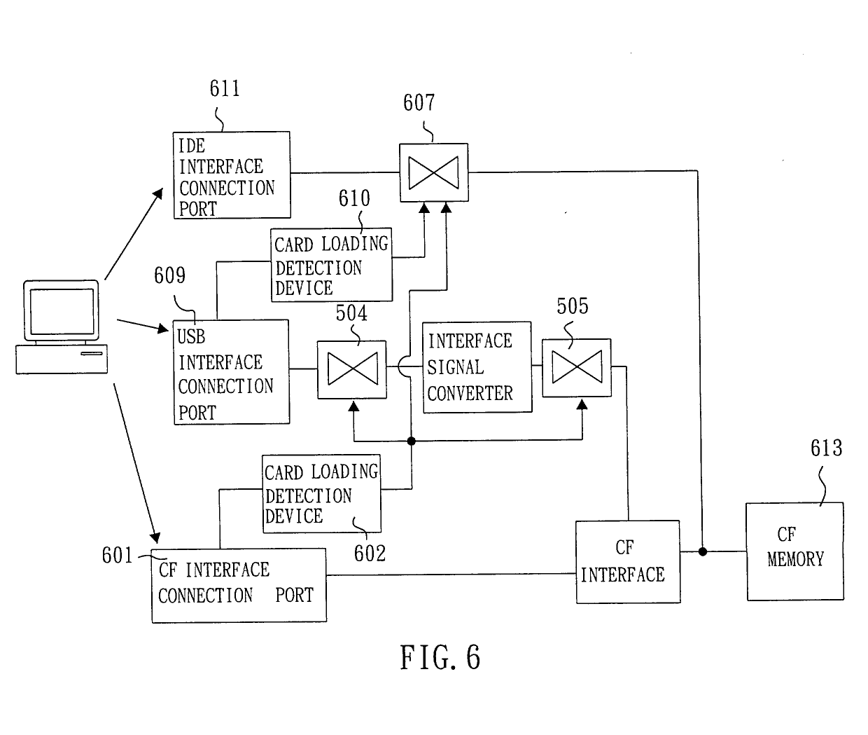

FIG. 6 shows a third embodiment of the present invention, which is a memory card with CF, USB and IDE interfaces. This embodiment is similar to the previous one except that the IDE interface connection port 611 replaces the ISA interface connection port 511. Because the CF memory 513 interface is an IDE interface, there is no need to have an interface signal converter for the IDE interface connection port 611, and only a switch device 607 is provided to connect the IDE interface connection port 611 to the CF memory 613. The card loading detection device 602 for detecting the CF interface connection port 601 and the card loading detection device 610 for detecting the USB interface connection port 609 both control the switch device's 607 on/off position.

In view of the foregoing, it is known that the present invention can appropriately turn on/off the switch devices by detecting the electronic card connection, so as to prevent active interface signals from being interfered with by inactive interface signals. Furthermore, with signal conversions , a single electronic card can be connected to an electronic device via the CF, USB, ISA and IDE interfaces, thereby achieving multiple interfacing and dramatically increasing electronic card applications.

Although the present invention has been explained in relation to its preferred embodiment, it is to be understood that many other possible modifications and variations can be made without departing from the spirit and scope of the invention as hereinafter claimed.

What is claimed is:

1. An electronic card with multiple interfaces comprising:
at least two interface connection ports, which include a first interface connection port and a second interface connection port;
an interface signal converter for converting signals of second interface connection port to signals of a predetermined interface, the predetermined interface corresponding and connecting to the first interface connection port;
a first switch device arranged between the second interface connection port and the interface signal converter;
a second switch device arranged between the interface signal converter and the predetermined interface; and
at least one card loading detection device for detecting whether the first interface connection port is connected to an electronic device, wherein, if the first interface connection port is connected to an electronic device, the card loading detection device turns off the first and second switch devices, and if the first interface connection port is not connected to an electronic device the card loading detection device turns on the first and second switches.

2. The electronic card with multiple interfaces as claimed in claim 1, wherein the first interface connection port is a CF interface connection port and the predetermined interface is a CF interface.

3. The electronic card with multiple interfaces as claimed in claim 1, wherein the card loading detection device has an OP amplifier to detect a short-circuit current in a card detection (CD) pin of the CF interface connection port to determine whether the CF interface connection port is connected to an electronic device.

4. The electronic card with multiple interfaces as claimed in claim 3, wherein the OP amplifier has a positive input and a negative input connected to ground and the CD pin, respectively, and an output connected to the negative input via a feedback resistor.

5. The electronic card with multiple interfaces as claimed in claim 2, wherein the second interface connection port is an USB interface connection port.

6. The electronic card with multiple interfaces as claimed in claim 5, wherein the interface signal converter is a serial to parallel signal converter for converting serial differential signals of USB interface to parallel signals of CF interface.

7. The electronic card with multiple interfaces as claimed in claim 6, wherein the first switch device comprises a plurality of analog switches, each connecting one pin of the USB interface connection port to the interface signal converter, and is controlled by the card loading detection device.

8. The electronic card with multiple interfaces as claimed in claim 6, wherein the second switch device comprises a plurality of bi-directional tri-state buffers, each connecting one pin of the interface signal converter to the CF interface, and is controlled by the card loading detection device.

9. The electronic card with multiple interfaces as claimed in claim 5, further comprising an IDE interface connection port which connects to the CF interface by a switch device, wherein the switch device is controlled by the card detection device and is turned off if the first interface connection port is connected to an electronic device; if the first interface connection port is not connected to an electronic device, the switch device is turned on.
